(19) United States
(12) Patent Application Publication
(10) Pub. No.: US 2025/0247756 A1
(43) Pub. Date: Jul. 31, 2025

(54) ELECTRONIC DEVICE, CONTROL METHOD THEREOF, AND MEDIUM

(71) Applicant: CANON KABUSHIKI KAISHA, Tokyo (JP)

(72) Inventor: YUICHIRO ARAKI, Kanagawa (JP)

(21) Appl. No.: 19/040,037

(22) Filed: Jan. 29, 2025

(30) Foreign Application Priority Data
Jan. 31, 2024 (JP) 2024-013306

(51) Int. Cl. H04W 36/08; H04W 36/30; H04W 76/10

(52) U.S. Cl. CPC H04W 36/08; H04W 36/30; H04W 76/10

(57) ABSTRACT

At least one embodiment of an electronic device capable of communicating with an external access point receives, from a first access point, a first change request requesting a change of a connection destination of the electronic device is provided herein. Based on the first change request, the device changes the connection destination of the electronic device to a second access point. In a state in which a connection to the first access point has been established, based on a trigger for updating a predetermined program included in the electronic device having occurred, the device disconnects the first connection and establishes a second connection to the electronic device, executes a predetermined control for preventing reception of the first change request via the second connection based on the trigger having occurred; and based on information received via the second connection established based on the trigger having occurred, updates the predetermined program.

### BACKGROUND

### Field of the Disclosure

One or more features of the present disclosure relate to one or more embodiments of an electronic device capable of connection by a wireless communication medium, such as a wireless Local Area Network (LAN), for example, a control method thereof, and a medium.

### Description of the Related Art

There is a technique for dynamically switching a connection destination AP so as to exchange data efficiently between an AP and a wireless station (STA) in an extended service set (ESS) constituted by a plurality of access points (AP). Upon determining that a connection destination AP is to be switched based on congestion of the AP to which the STA is connected and vacancy, signal conditions, and the like of other APs, the connected AP transmits a connected AP change request to the STA. When an AP change request is received, the STA switches the connection destination AP according to the request and can thereby connect to an appropriate AP.

Japanese Patent Laid-Open No. 2021-175068 discloses the following as processing for a router having the functions of an AP to request a connected wireless station to change the connection destination. A mobile router (MR1) that can connect with a plurality of wireless stations confirms whether the wireless station terminals support IEEE 802.11v. Whether a wireless station terminal supports IEEE 802.11v can be determined from an Association Request frame, which is transmitted when the wireless station terminal wirelessly connects to MR1. If a wireless station terminal supports IEEE 802.11v, a BSS Transition Management (BTM) Request frame is transmitted to that wireless station terminal. Here, BSS is an abbreviation of basic service set. In a BSS Transition Candidate List Entries field of the BTM Request frame, the BSSID of a master router RT2 is designated as the connection destination. A wireless station terminal is thus prompted to switch the connection destination, and the wireless station terminal switches the connection destination from MR1 to RT2 according to the received BTM Request frame.

An STA has a state in which no issue occurs even when the AP is switched and a state in which an issue occurs when the AP is switched or when the STA is disconnected from the connected AP. In the state in which an issue occurs, if an AP change request is received from the AP and the connection destination AP is switched in response to the request, the STA will experience an issue.

For example, when an STA executes a firmware update, if the connection destination AP is switched during communication, an error may occur in data communication, and as a result, the firmware update may fail.

### SUMMARY

One or more aspects of embodiments of the present disclosure provide a mechanism that performs a firmware update via a wireless connection more reliably.

One or more aspects that may be used in one or more embodiments of the present disclosure provide an electronic device capable of communicating or that operates to communicate with an external access point, where the electronic device may include: at least one memory storing instructions; and at least one processor that is in communication with the at least one memory and that, when executing the instructions, cooperates and operates with the at least one memory to execute processing, the processing including establishing a first connection between the electronic device and a first access point; receiving, from the first access point, a first change request requesting a change of a connection destination of the electronic device; based on the first change request being received, changing the connection destination of the electronic device to a second access point included in one or more access points corresponding to information included in the first change request; in a state in which the first connection has been established, based on a predetermined trigger for updating a predetermined program included in the electronic device having occurred, executing a first processing for disconnecting the first connection and a second processing for establishing a second connection between the electronic device and the first access point; executing a predetermined control for preventing reception of the first change request via the second connection established by the second processing being executed based on the predetermined trigger having occurred; and based on information received via the second connection established by the second processing being executed based on the predetermined trigger having occurred, updating the predetermined program.

One or more other aspects of the present disclosure provide a method of controlling an electronic device capable of communicating or operating to communicate with an external access point, the method comprising: establishing a first connection between the electronic device and a first access point; receiving, from the first access point, a first change request requesting a change of a connection destination of the electronic device; based on the first change request being received, changing the connection destination of the electronic device to a second access point included in one or more access points corresponding to information included in the first change request; in a state in which the first connection has been established, based on a predetermined trigger for updating a predetermined program included in the electronic device having occurred, executing a first processing for disconnecting the first connection and a second processing for establishing a second connection between the electronic device and the first access point; executing a predetermined control for preventing reception of the first change request via the second connection established by the second processing being executed based on the predetermined trigger having occurred; and based on information received via the second connection established by the second processing being executed based on the predetermined trigger having occurred, updating the predetermined program.

Still one or more further aspects of the present disclosure provide a non-transitory computer readable medium storing a program that, when executed by an electronic device capable of communicating or operating to communicate with an external access point, causes the electronic device to perform a method, the method comprising: establishing a first connection between the electronic device and a first access point; receiving, from the first access point, a first change request requesting a change of a connection destination of the electronic device; based on the first change request being received, changing the connection destination of the electronic device to a second access point included in one or more access points corresponding to information included in the first change request; in a state in which the first connection has been established, based on a predetermined trigger for updating a predetermined program included in the electronic device having occurred, executing a first processing for disconnecting the first connection and a second processing for establishing a second connection between the electronic device and the first access point; executing a predetermined control for preventing reception of the first change request via the second connection established by the second processing being executed based on the predetermined trigger having occurred; and based on information received via the second connection established by the second processing being executed based on the predetermined trigger having occurred, updating the predetermined program.

According to one or more aspects of the present disclosure, it is possible to perform a firmware update via a wireless connection more reliably.

According to other aspects of the present disclosure, one or more additional electronic devices, one or more additional methods, and one or more additional storage mediums are discussed herein. Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of a system according to one or more embodiments of the present disclosure.

FIG. 2A is a diagram illustrating an example of an appearance of a Multi-Function Peripheral (MFP) according to one or more embodiments of the present disclosure.

FIG. 2B is a diagram illustrating an example of a configuration of the MFP according to one or more embodiments of the present disclosure.

FIGS. 3A to 3C are diagrams illustrating examples of display in an operation display unit of the MFP according to one or more embodiments of the present disclosure.

FIG. 4A is a diagram illustrating an appearance of a mobile terminal device according to one or more embodiments of the present disclosure.

FIG. 4B is a diagram illustrating a configuration of the mobile terminal device according to one or more embodiments of the present disclosure.

FIG. 5 is a diagram of a configuration of an access point according to one or more embodiments of the present disclosure.

FIG. 6 is a sequence diagram for explaining processing performed in response to a connection destination change request from the AP according to one or more embodiments of the present disclosure.

FIGS. 7A and 7B are a flowchart for when executing a firmware update according to one or more embodiments of the present disclosure.

FIG. 8 is a flowchart for when executing a firmware update according to one or more embodiments of the present disclosure.

FIG. 9 is a flowchart for explaining control of a connection destination change request from the AP according to one or more embodiments of the present disclosure.

### DESCRIPTION OF THE EMBODIMENTS

Hereinafter, one or more embodiments and/or features of the present disclosure will be described in detail with reference to the attached drawings. Note, the following embodiments are not intended to limit the scope of the claims of the present disclosure. Multiple features are described in the embodiments, but limitation is not made to an embodiment that requires all such features, and multiple such features may be combined as appropriate. Configurations in the following embodiments are merely examples, and the present technique(s)/feature(s) of the present disclosure is/are not limited to the illustrated configurations. Furthermore, in the attached drawings, the same reference numerals are given to the same or similar configurations, and redundant descriptions thereof are omitted.

Details of one or more embodiments of the present disclosure follow below:

### Configuration of One or More System Embodiments

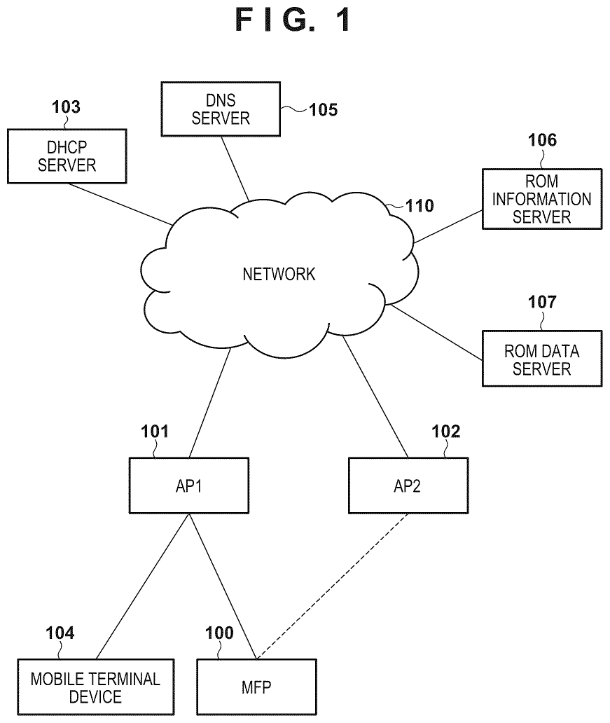

FIG. 1 illustrates an example of a configuration of a system according to one or more embodiments of the present disclosure. In one example, the system may be a wireless communication system in which a plurality of communication devices can wirelessly communicate with each other. The example of FIG. 1 includes, as communication devices, a mobile terminal device 104, an MFP 100, and an AP 101 and an AP 102, which are access points (hereinafter, AP), and a Dynamic Host Configuration Protocol (DHCP) server 103, a Domain Name System (DNS) server 105, and a network 110. The AP 101 and the AP 102 may be illustrated as AP1 and AP2. The AP 101 and the AP 102 may be, for example, one or more wireless LAN routers. The AP 101 and the AP 102 may be separate APs that are enabled by separate wireless LAN routers or may be separate APs that are enabled by a single wireless LAN router but use different frequency bands. A Read-Only Memory (ROM) information server 106 and a ROM data server 107, which are servers for updating firmware of the MFP 100, are further included in the embodiment of FIG. 1. The mobile terminal device 104 is a device having a function for wireless communication by a wireless LAN or the like. In the following, a wireless LAN may be referred to as a WLAN. The mobile terminal device 104 may be a personal information terminal (e.g., a personal digital assistant (PDA)), a mobile telephone (smartphone), a digital camera, a personal computer, or the like. In one or more embodiments, it is assumed that a connection between the mobile terminal device 104 and an AP and a connection between the MFP 100 and an AP are connections according to a communication method based on an IEEE 802.11 series standard. The communication method based on an IEEE 802.11 series standard is, specifically, Wireless Fidelity (Wi-Fi)®.

The MFP 100 is a printing device or an image forming device having a printing function and may further include a reading function (scanner), a facsimile (FAX) function, and a telephone function. Further, the MFP 100 for one or more embodiments has a communication function that allows wireless communication with the mobile terminal device 104. Further, in one or more embodiments, a case where the MFP 100 is used will be described as an example, but the one or more embodiments of the present disclosure are not limited thereto. For example, a scanner device, a projector, a mobile terminal, a smartphone, a notebook PC, a tablet terminal, a PDA, a digital camera, a music player, a TV, a smart speaker, or the like, each having a communication function, may be used in place of the MFP 100. As aforementioned, MFP is an acronym for Multi-Function Peripheral.

The AP 101 is provided separately from (external to) the mobile terminal device 104 and the MFP 100 and operates as a WLAN base station device. A communication device having a WLAN communication function can communicate in WLAN infrastructure mode via the AP 101. In the following, an access point may be referred to as an “AP”. The infrastructure mode may be referred to as the “wireless infrastructure mode.” The AP 101 performs wireless communication with an (authenticated) communication device with which it has permitted to connect, and relays wireless communication between that communication device and another communication device. The AP 101 may, for example, be connected to a wired communication network and relay communication between a communication device connected to the wired communication network and another communication device wirelessly connected to the AP 101.

The AP 102 has the same functions as the AP 101, and the MFP 100 switches the connection from the AP 101 to the AP 102 as necessary. The DHCP server 103 connects with the MFP 100 through the network 110 and the AP 101 and, by responding to requests from the MFP 100, provides services to the MFP 100. A configuration in which the DHCP server 103 is connected as a device separate from the AP 101 and the AP 102 in FIG. 1 has been described, but a configuration in which the AP 101 and the AP 102 have a DHCP server function may be taken or used in one or more embodiments. The DNS server 105 is connected with the MFP 100 and the mobile terminal device 104 through the network 110 and the AP 101 and, by responding to requests from the MFP 100 and the mobile terminal device 104, provides services for name resolution. The ROM information server 106 holds information related to firmware of the MFP 100 and is accessed by the MFP 100 to confirm whether there is a newer version of the firmware. The ROM data server 107 holds the actual firmware (i.e., programs and data) of the MFP 100 and is accessed by the MFP 100 for download at the time of a firmware update. Here, the ROM information server 106 and the ROM data server 107 may be the same server or different servers in one or more embodiments. Here, the network 110 may be the so-called Internet or may be a closed network in a company or a mobile phone network.

### External Configuration of MFP for One or More Embodiments

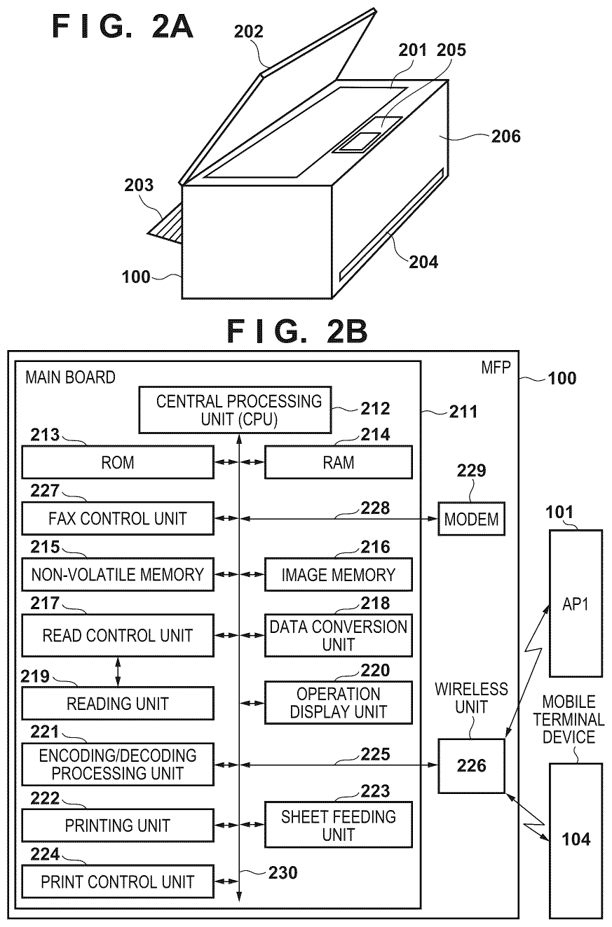

FIG. 2A illustrates an example of an external configuration of the MFP 100. The MFP 100 includes, for example, a document table 201, a document cover 202, a printing sheet insertion port 203, a printing sheet discharge port 204, and an operation display unit 205. The document table 201 is a table on which a document to be read is placed. The document cover 202 is a cover for holding a document placed on the document table 201 and for preventing light from a light source that irradiates the document from leaking out at the time of reading. The printing sheet insertion port 203 is an insertion port in which sheets of various sizes can be set. The printing sheet discharge port 204 is a discharge port for discharging a sheet on which printing has been completed. Sheets set in the printing sheet insertion port 203 are conveyed to a printing unit one at a time and, after printing has been performed thereon in the printing unit, are discharged from the printing sheet discharge port 204. The operation display unit 205 is configured to include keys (e.g., character input keys, a cursor key, an enter key, and a cancel key), an LED or LCD, and the like, and is configured to be capable of accepting activation of various functions and operations for various settings for the MFP by a user. The operation display unit 205 may be configured to include a touch panel display. The MFP 100 has a function for wireless communication by a WLAN and is configured to include, for wireless communication therefor, an antenna 206 for wireless communication although it need not necessarily be externally visible. Similarly to the mobile terminal device 104, the MFP 100 can perform wireless communication in 2.4-GHz and 5-GHz frequency bands by a WLAN.

### Configuration of the MFP for One or More Embodiments

FIG. 2B illustrates an example of a configuration of the MFP 100. The MFP 100 is configured to include a main board 211, which performs main control of the device itself, and a wireless unit 226, which is one of the communication modules that perform WLAN communication using at least one common antenna. The MFP 100 is configured to include a modem 229 for performing, for example, wired communication. The main board 211 is configured to include, for example, a central processing unit (CPU) 212, a ROM 213, a Random Access Memory (RAM) 214, a non-volatile memory 215, an image memory 216, a read control unit 217, a data conversion unit 218, a reading unit 219, and an encoding/decoding processing unit 221. Further, the main board 211 includes, for example, a printing unit 222, a sheet feeding unit 223, a print control unit 224, and an operation display unit 220. These functional units in the main board 211 are connected to each other through a system bus 230 managed by the CPU 212. Further, the main board 211 and the wireless unit 226 are connected, for example, via a dedicated bus 225, and the main board 211 and the modem 229 are connected, for example, via a bus 228.

The CPU 212 is a system control unit including at least one processor and controls the entire MFP 100. The processes of the MFP 100 to be described below are realized, in one example, by the CPU 212 executing a program stored in the ROM 213. Dedicated hardware for each process may be provided. The ROM 213 is an example of a computer-readable storage medium for storing control programs, an embedded OS program, and the like to be executed by the CPU 212. The OS is an operating system. In one or more embodiments, the CPU 212 performs software control, such as scheduling and task switching, by executing the respective control programs stored in the ROM 213 under the control of the embedded OS, which is similarly stored in the ROM 213.

The RAM 214 is constituted by a Static RAM (SRAM) or the like. The RAM 214 stores data such as program control variables and data such as setting values registered by the user and management data of the MFP 100. The RAM 214 may be used as a buffer for various kinds of work. The non-volatile memory 215 is constituted by a memory, such as a flash memory, for example, and continues to store data even when the power of the MFP 100 is turned off. The image memory 216 is constituted by a memory such as a Dynamic RAM (DRAM). The image memory 216 stores image data received through the wireless unit 226, image data processed by the encoding/decoding processing unit 221, and the like. The memory configuration of the MFP 100 is not limited to the above configuration. The data conversion unit 218, for example, performs analysis of data in various formats and converts image data to print data.

The read control unit 217 controls the reading unit 219 (e.g. a contact image sensor (CIS)) to optically read a document placed on the document table 201. The read control unit 217 converts an image obtained by optically reading the document into electrical image data (image signal) and outputs it. At this time, the read control unit 217 may output the image data after performing various kinds of image processing such as binary processing and halftone processing.

The operation display unit 220 is the operation display unit 205 described with reference to FIG. 2A and, for example, executes display on a display based on display control by the CPU 212 and generates a signal corresponding to acceptance of a user operation.

The encoding/decoding processing unit 221 performs encoding processing and decoding processing of image data (JPEG, PNG, etc.) handled by the MFP 100 and enlargement/reduction processing.

The sheet feeding unit 223 holds sheets for printing. The sheet feeding unit 223 can supply a set sheet under the control of the print control unit 224. The sheet feeding unit 223 may include a plurality of sheet feeding units so as to hold a plurality of types of sheets in a single device, and can control which sheet feeding unit to feed a sheet from under the control of the print control unit 224.

The print control unit 224 performs various kinds of image processing, such as smoothing processing, printing density correction processing, and color correction, on image data to be printed and outputs the processed image data to the printing unit 222. The printing unit 222 is configured to be capable of executing, for example, inkjet printing processing, and prints an image on a printing medium, such as a sheet, by causing a print head to discharge ink supplied from an ink tank. The printing unit 222 may be configured to be capable of executing another kind of printing processing such as electrophotographic printing processing. The print control unit 224 may periodically read out information of the printing unit 222 and update, for example, status information including the remaining amount of the ink tank, the status of the print head, and the like stored in the RAM 214.

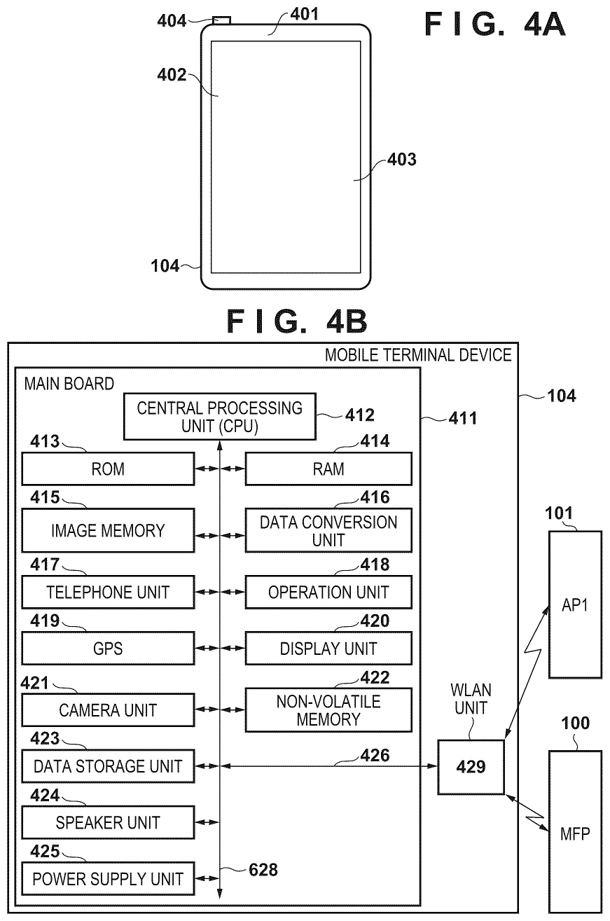

The wireless unit 226 is a unit capable of providing a WLAN communication function and, for example, can provide a function similar to what incorporates a WLAN unit 429 of the mobile terminal device 104 (as shown in FIG. 4B and as discussed below). That is, the wireless unit 226 converts data into packets and transmits the packets to another device according to a WLAN standard, and reconstructs original data from packets from another, external device and outputs it to the CPU 212. The wireless unit 226 is capable of communicating as a station conforming to the IEEE 802.11 standard series, in particular, a station conforming to IEEE 802.11a/b/g/n/ac/ax. In the following, a station may be referred to as an STA, and is capable of communicating as an STA supporting Wi-Fi Agile Multiband™.

The wireless unit 226 supports IEEE 802.11ax, that is, Wi-Fi6™, and the MFP 100 can also operate as an STA supporting (conforming to) at least one of OFDMA and TWT. Here, OFDMA is an abbreviation of Orthogonal Frequency-Division Multiple Access. TWT is an abbreviation of Target Wake Time. Since TWT is supported, a timing of data communication from a master device to an STA is adjusted. The wireless unit 226 (MFP 100), which is an STA, causes the communication function to transition to a sleep state when there is no need to stand by for signal reception. By this, power consumption can be reduced. Further, the wireless unit 226 supports Wi-Fi 6ETM. That is, it can also communicate in a 6-GHz band (5.925 GHz to 7.125 GHZ). Frequency bands in the 5-GHz band that are targets of Dynamic Frequency Selection (DFS) are not in the 6-GHz band. Therefore, in communication in the 6-GHz band, communication disconnection due to DFS standby time does not occur, and more reliable or consistent communication can be expected.

The mobile terminal device 104 and the MFP 100 are capable of Peer-to-Peer P2P (WLAN) communication that is based on Wi-Fi Direct (WFD), and the wireless unit 226 has a software access point (soft AP) function or a group owner function. That is, the wireless unit 226 can construct a P2P communication network and determine the channel to be used in P2P communication.

### Operation Display Unit of MFP in One or More Embodiments

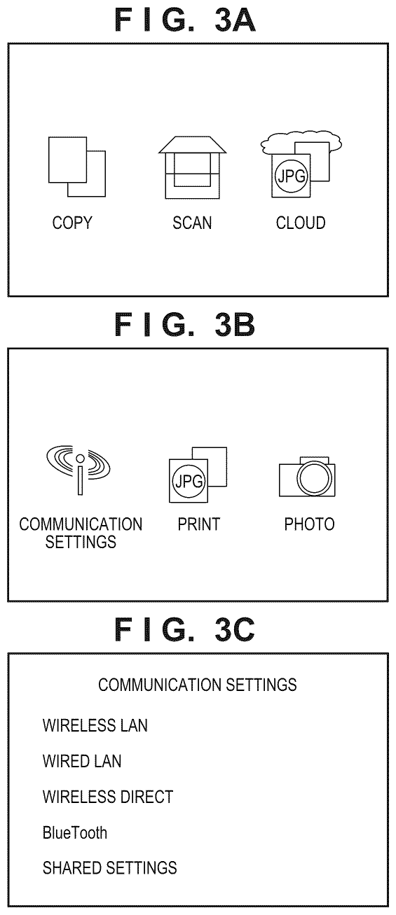

FIGS. 3A to 3C schematically illustrate examples of screen displays in a display (touch panel display) included in the operation display unit 220 of the MFP 100 for one or more embodiments. FIG. 3A is an example of a home screen to be displayed when the power of the MFP 100 is turned on and while no operation, such as printing or scanning, is being performed (idle state and standby state). In FIG. 3A, display items (menu items), respectively corresponding to copy, scan, and cloud, are displayed. Cloud is a menu item related to a cloud function that uses Internet communication. The MFP 100 may start execution of a corresponding setting or function by one of the menu items being selected by a key operation or a touch panel operation. The MFP 100 can display a screen that is different from FIG. 3A in a seamless manner by receiving a key operation or a touch panel operation on the home screen in FIG. 3A.

FIG. 3B is an example of display of another part of the home screen and is a screen to which transition is made from the state of FIG. 3A by an operation (e.g., a left/right sliding operation) for displaying another page of the home screen. In FIG. 3B, display items (menu items), respectively corresponding to communication settings, print, and photo, are displayed. When one of these menu items is selected, the function, that is, a print function, a photo function, or communication settings, corresponding to the selected menu item is executed.

FIG. 3C is an example of a display of a communication setting menu screen to be displayed when communication settings is selected on the screen of FIG. 3B. “Wireless LAN”, “wired LAN”, “Wireless Direct”, “Bluetooth” and “shared settings” are displayed as menu items (options) on the communication setting menu screen. “Wireless LAN”, “wired LAN”, and “Wireless Direct” are menu items for performing LAN settings, and from these items, settings such as wired connection settings, a wireless infrastructure mode enable/disable setting, and a P2P mode (e.g., WFD and soft AP mode) enable/disable setting can be performed. If the item “wireless LAN” is selected and a wireless LAN is set to enabled by a user operation, wireless infrastructure mode will be enabled. If the item “Wireless Direct” is selected and Wireless Direct is set to enabled by a user operation, P2P (WLAN) mode will be enabled. In addition, this screen displays a shared setting menu related to each form of connection. Further, from this screen, the user can perform, for example, wireless LAN frequency band and frequency channel settings.

### External Configuration of Mobile Terminal Device in One or More Embodiments

FIG. 4A is a diagram illustrating an example of an external configuration of the mobile terminal device 104. In one or more embodiments, as one example, a case where the mobile terminal device 104 is a common type of smartphone will be described. The mobile terminal device 104 is configured to include, for example, a display unit 402, an operation unit 403, and a power key 404. The display unit 402 is, for example, a display that includes a liquid crystal display (LCD) mechanism. The display unit 402 may display information using, for example, light emitting diodes (LEDs) and the like. In addition to or in place of the display unit 402, the mobile terminal device 104 may have a function for outputting information by voice. The operation unit 403 is configured to include physical keys (e.g., keys and buttons), a touch panel, and the like for detecting user operations. In this example, since display of information on the display unit 402 and reception of user operations by the operation unit 403 are performed using the same touch panel display, the display unit 402 and the operation unit 403 are realized by one device. In this case, for example, button icons and a software keyboard are displayed using the display function of the display unit 402, and the user's touch on those locations is detected by the operation reception function of the operation unit 403. A configuration may be taken so as to separate the display unit 402 and the operation unit 403 and separately provide hardware for display and hardware for operation reception. The power key 404 is a physical key for receiving a user operation for turning the power of the mobile terminal device 104 on or off.

The mobile terminal device 104 includes a WLAN unit 401, which provides a WLAN communication function, although it need not necessarily be externally visible. The WLAN unit 401 is configured to be capable of executing data (packet) communication in a WLAN system conforming to, for example, the IEEE 802.11 standard series (e.g., IEEE 802.11a/b/g/n/ac/ax), and is capable of communicating as an AP supporting Wi-Fi Agile Multiband™. However, the WLAN unit 401 is not limited thereto and may be capable of performing communication in a WLAN system conforming to another standard. In this example, it is assumed that the WLAN unit 401 is capable of performing communication in both the 2.4-GHz and 5-GHz frequency bands. Further, it is assumed that the WLAN unit 401 is capable of performing communication based on WFD, communication according to the soft AP mode, communication according to the wireless infrastructure mode, and the like. Operations in these modes will be described later.

### Configuration of Mobile Terminal Device in One or More Embodiments

FIG. 4B illustrates an example of a configuration of the mobile terminal device 104. The mobile terminal device 104 includes, in one example, a main board 411, which performs main control of the device itself, and the WLAN unit 429, which performs WLAN communication. The main board 411 includes, for example, a CPU 412, a ROM 413, a RAM 414, an image memory 415, a data conversion unit 416, a telephone unit 417, a GPS 419, a camera unit 421, a non-volatile memory 422, a data storage unit 423, a speaker unit 424, and a power supply unit 425. Here, CPU is an acronym for central processing unit, ROM for read only memory, RAM for random access memory, and GPS for Global Positioning System. Further, the mobile terminal device 104 includes a display unit 420 and an operation unit 418. These functional units in the main board 411 are connected to each other through a system bus 628 managed by the CPU 412. Further, the main board 411 and the WLAN unit 429 are connected, for example, via a dedicated bus 426.

The CPU 412 is a system control unit including at least one processor and controls the entire mobile terminal device 104. The processes of the mobile terminal device 104 to be described below are realized, in one example, by the CPU 412 executing a program stored in the ROM 413. Dedicated hardware for each process may be provided. The ROM 413 stores control programs, an embedded operating system (OS) program, and the like to be executed by the CPU 412. In one or more embodiments, the CPU 412 performs software control, such as scheduling and task switching, by executing the respective control programs stored in the ROM 413 under the control of the embedded OS, which is similarly stored in the ROM 413.

The RAM 414 is constituted by a static RAM (SRAM) or the like. The RAM 414 stores data such as program control variables and data such as setting values registered by the user and management data of the mobile terminal device 104. The RAM 414 may be used as a buffer for various kinds of work. The image memory 415 is constituted by a memory such as a dynamic RAM (DRAM). The image memory 415 temporarily stores image data received through the WLAN unit 429 and image data read from the data storage unit 423 for processing in the CPU 412. The non-volatile memory 422 is constituted by a memory, such as a flash memory, for example, and continues to store data even when the power of the mobile terminal device 104 is turned off. The memory configuration of the mobile terminal device 104 is not limited to the above configuration. For example, the image memory 415 and the RAM 414 may be shared, or the data storage unit 423 may be used, for example, to back up data. Further, although a DRAM has been given as an example of the image memory 415 in one or more embodiments, another storage medium, such as a hard disk or a non-volatile memory, may be used.

The data conversion unit 416 analyzes various types of data and performs data conversion, such as color conversion and image conversion. The telephone unit 417 controls the telephone line and realizes communication by telephone by processing voice data inputted and outputted through the speaker unit 424. The GPS 419 receives radio waves transmitted from satellites and obtains position information of the mobile terminal device 104, such as the current latitude and longitude.

The camera unit 421 has a function for electronically recording and encoding an image inputted through a lens. Image data obtained by imaging by the camera unit 421 is stored in the data storage unit 423. The speaker unit 424 performs control for realizing a function for inputting or outputting a voice for the telephone function and a function for alarm notification and the like. The power supply unit 425 is, for example, a portable battery, and performs control for supplying power to the device. Power states include, for example, a battery exhausted state in which there is no remaining power in the battery, a power-off state in which the power key 404 has not been pressed, an active state in which the device is operating normally, and a power saving state in which the device is operating but saving power.

The display unit 420 is the display unit 402 described with reference to FIG. 4A and performs, for example, display of the status and the operation status of the MFP 100 and various input operations, based on the control of the CPU 412. The operation unit 418 is the operation unit 403 described with reference to FIG. 4A and, upon receiving a user operation, executes control such as generating an electric signal corresponding to the operation and outputting it to the CPU 412.

The mobile terminal device 104 performs wireless communication using the WLAN unit 429 and performs data communication with another device, such as the MFP 100. The WLAN unit 429 converts data into packets and transmits the packets to another device. The WLAN unit 429 reconstructs original data from packets from another, external device and outputs it to the CPU 412. The WLAN unit 429 is a unit for realizing communications, respectively conforming to the WLAN standards. The WLAN unit 429 can operate in parallel in at least two communication modes, including the wireless infrastructure mode and the P2P (WLAN) mode. The frequency bands to be used in these communication modes may be limited according to the functions and performance of the hardware.

### Configuration of an Access Point for One or More Embodiments

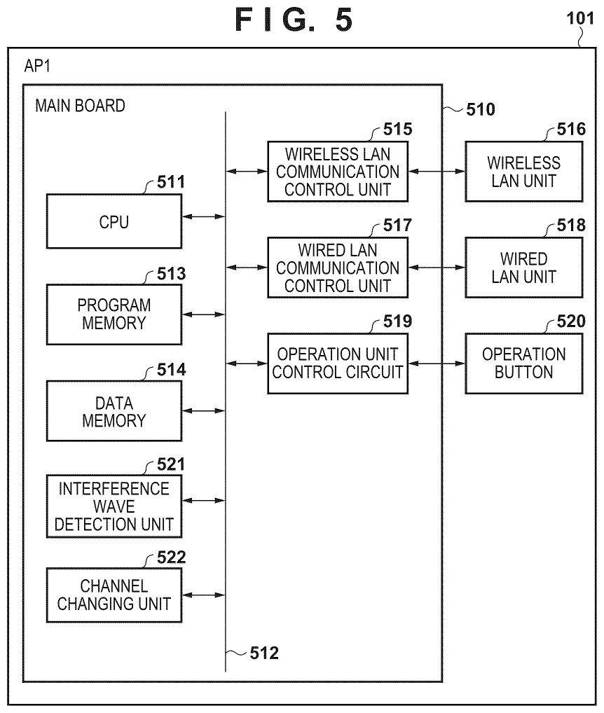

FIG. 5 is a block diagram illustrating a configuration of the AP 101 having a wireless LAN access point function. The AP 101 is configured to include a main board 510 which controls the AP 101, a wireless LAN unit 516, a wired LAN unit 518, and an operation button 520.

A CPU 511 in the form of a microprocessor arranged on the main board 510 operates according to a control program stored in a program memory 513 in the form of a ROM connected via an internal bus 512 and the contents of a data memory 514 in the form of a RAM. The CPU 511 performs wireless LAN communication with another communication terminal device by controlling the wireless LAN unit 516 through a wireless LAN communication control unit 515. The CPU 511 performs wired LAN communication with another communication terminal device by controlling the wired LAN unit 518 through a wired LAN communication control unit 517. The CPU 511 can receive an operation from the user through the operation button 520 by controlling an operation unit control circuit 519. The CPU 511 includes at least one processor.

Further, the AP 101 includes an interference wave detection unit 521 and a channel change unit 522 (also referred to as a “channel changing unit”). The interference wave detection unit 521 performs processing for detecting an interference wave when wireless communication is being performed in a frequency band in which Dynamic Frequency Selection (DFS) is performed. The channel change unit 522 performs processing for changing a channel to be used, for example, if an interference wave is detected or if an immediate change to a vacant channel is necessary, when wireless communication is being performed in a frequency band in which DFS is performed.

The AP 102 has a configuration similar to that of the AP 101.

### P2P Communication Method in one or More Embodiments

Next, a P2P (WLAN) communication system in which devices wirelessly communicate in a direct manner with each other without going through an external access point in WLAN communication will be outlined. P2P (WLAN) communication can be realized using a plurality of methods, and for example, a communication device can support a plurality of modes for P2P (WLAN) communication and selectively use any of the plurality of modes to perform P2P (WLAN) communication.

The following two modes are assumed as the P2P mode for one or more embodiments.
Soft AP Mode
Wi-Fi Direct (WFD) Mode

A communication device capable of executing P2P communication may be configured to support at least one of these modes. Meanwhile, a communication device capable of executing P2P communication need not support each of these modes and may be configured to support only one of them.

In a communication device (e.g., the mobile terminal device 104) having a communication function according to WFD, upon reception of a user operation through the operation unit thereof, an (in some cases, dedicated) application for realizing that communication function is called. The communication device may then display a user interface (UI) screen provided by that application to prompt a user operation and, based on the received user operation in response thereto, execute WFD communication.

### Soft AP Mode for One or More Embodiments

In the soft AP mode, a communication device (e.g., the mobile terminal device 104) operates as a client, which requests various services. Another communication device (e.g., the MFP 100) operates as a software AP capable of executing a WLAN AP function with software-based settings. Regarding commands and parameters transmitted and received when a wireless connection is established between a client and a software AP, it is enough that those specified in the Wi-Fi® standard are used, and so, the description here will be omitted. The MFP 100, which operates in the soft AP mode, determines the frequency band and the frequency channel as the master station. Therefore, the MFP 100 can select which frequency band to use between 5 GHz and 2.4 GHz and which frequency channel to use in that frequency band.

### WFD Mode for One or More Embodiments

The MFP 100 may always operate as a WFD mode master station (Autonomous Group Owner). In this case, GO Negotiation processing for determining roles is unnecessary. Further, in this case, the MFP 100 determines the frequency band and the frequency channel as the master station. Therefore, the MFP 100 can select which frequency band to use between 5 GHz and 2.4 GHz and which frequency channel to use in that frequency band.

### Wireless Infrastructure Mode for One or More Embodiments

In the wireless infrastructure mode, communication devices (e.g., the mobile terminal device 104 and the MFP 100) that communicate with each other are connected to an external AP (e.g., the AP 101) that controls a network, and communication between the communication devices is performed through that AP. In other words, communication between communication devices is performed via a network constructed by an external AP. The mobile terminal device 104 and the MFP 100 each discovering the AP 101, transmitting a connection request to the AP 101, and establishing a connection enables communication between these communication devices in the wireless infrastructure mode via the AP 101. A plurality of communication devices may be connected to different APs. In this case, data transfer between the APs enables communication between the communication devices. Regarding commands and parameters transmitted and received when communication devices communicate via an access point, it is enough that those specified in the Wi-Fi standard are used, and so, the description here will be omitted. Further, in this case, the AP 101 determines the frequency band and the frequency channel. Therefore, the AP 101 can select which frequency band to use among 5 GHZ, 2.4 GHZ, and 6 GHz and which frequency channel to use in that frequency band.

### User-Set AP in One or More Embodiments

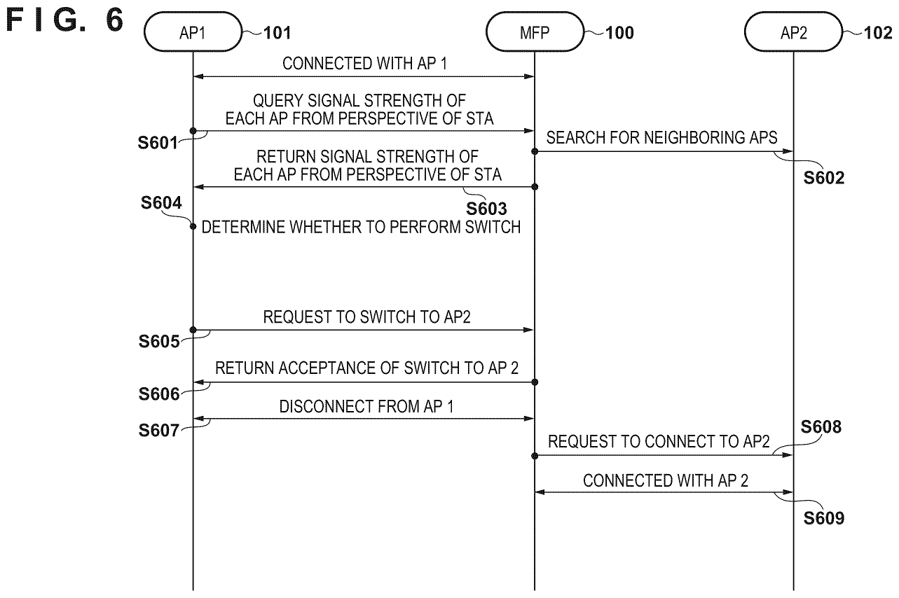

The MFP 100 operating as an STA can be connected to an AP by a user operation for selecting and determining an external AP to be the connection destination of the MFP 100 being performed. In the following description, an AP determined by a user operation may be referred to as a “user-set AP”. A user-set AP is, for example, an AP set as the connection destination AP of the MFP 100 by the user operating the MFP 100, the mobile terminal device 104, or the like. In other words, a user-set AP is an AP to which the MFP 100 is connected before the connection destination is switched according to Wi-Fi Agile Multiband. Further, in other words, a user-set AP is an AP that is different from an AP to which the MFP 100 has connected by the connection destination being switched according to Wi-Fi Agile Multiband. A switch of the connection destination according to Wi-Fi Agile Multiband will be described in FIG. 6. A user-set AP is, for example, a high-performance AP or the like, and is, for example, an AP capable of communicating in the 5-GHz frequency band.

### <Wi-Fi Agile Multiband>

Wi-Fi Agile Multiband is a function conforming to IEEE 802.11v, IEEE 802.11r, and IEEE 802.11k standards and is a function for controlling a communication device to connect with an appropriate network according to the states of networks in the vicinity of the communication device. This function will also be referred to as a band steering function in the following. In one or more embodiments, it is assumed that the mobile terminal device 104 and the MFP 100 support the Wi-Fi Agile Multiband® function and can communicate as STAs supporting Wi-Fi Agile Multiband. Further, it is assumed that the mobile terminal device 104 and the MFP 100 supports the Wi-Fi 6® function, which is a function conforming to the IEEE 802.11ax standard. With this, it is assumed that the mobile terminal device 104 and the MFP 100 are capable of executing, as the Wi-Fi 6® function, operation as STAs supporting Orthogonal Frequency-Division Multiple Access (OFDMA) and Target Wake Time (TWT). The mobile terminal device 104 and the MFP 100, which are STAs, can reduce power consumption by causing the communication function to transition to a sleep state when there is no need to stand by for signal reception. The mobile terminal device 104 and the MFP 100 may support, specifically, a Wi-Fi 6ER function as the Wi-Fi 6 function in one or more embodiments. That is, the mobile terminal device 104 and the MFP 100 may be capable of communication in the 6-GHz band (5.925 GHz to 7.125 GHZ). In the 6-GHz band, unlike the 5-GHz band, there are no frequency bands that are targets of Dynamic Frequency Selection (DFS). Therefore, in communication in the 6-GHz band, communication disconnection due to DFS standby time does not occur. As described above, in one or more embodiments, it is assumed that the mobile terminal device 104 and the MFP 100 support both Wi-Fi Agile Multiband and Wi-Fi 6 but are not limited to this form. For example, the mobile terminal device 104 and the MFP 100 may support Wi-Fi Agile Multiband but need not support Wi-Fi 6. Further, as will be described later, an issue to be addressed by one or more features of the present disclosure may arise also in a situation in which although one of the mobile terminal device 104 and the MFP 100 does not support Wi-Fi Agile Multiband, the other of the mobile terminal device 104 and the MFP 100 supports Wi-Fi Agile Multiband. Therefore, one of the mobile terminal device 104 and the MFP 100 need not support Wi-Fi Agile Multiband.

Regarding a wireless LAN router in which this function is enabled, a plurality of access points, each using a different frequency band, are enabled, and the ESSIDs of respective access points are set to the same name. ESSID is Extended Service Set Identifier. In one or more embodiments, for example, it is assumed that regarding one router in which the band steering function is enabled, a first access point to which a connection can be established using a first frequency band and a second access point to which a connection can be established using a second frequency band are activated. The first access point is, for example, the AP 101, and the second access point is, for example, the AP 102. When the communication environment in which the first frequency band is used becomes unstable while the MFP 100 is connected to the first access point, the wireless LAN router instructs the MFP 100 to switch (change) the connection destination to the second access point, which forms a network that uses the second frequency band and is a network with a better communication environment. With this, the MFP 100 switches the connection destination to the second access point. Similarly when the communication environment in which the first frequency band is used becomes unstable while the mobile terminal device 104 is connected to the first access point, the wireless LAN router instructs the mobile terminal device 104 to switch the connection destination to the second access point. With this, the mobile terminal device 104 switches the connection destination to the second access point. Whether the communication environment is unstable is determined by the wireless LAN router based on, for example, the signal strength and the amount of noise signals, which are identified based on information received by the wireless LAN router from the MFP 100 or the mobile terminal device 104, and the numbers of devices that are connected to the respective access points enabled in the wireless LAN router. With this, the mobile terminal device 104 and the MFP 100, which are clients supporting the band steering function, can, after connecting with one of the plurality of access points, automatically switch the connection destination to another access point that uses a frequency band with a good communication environment. That is, in one or more embodiments, it is assumed that the MFP 100 is capable of using a plurality of frequency bands including the first frequency band and the second frequency band. Further, it is assumed that regarding one router in which the band steering function is enabled, the first access point with which a connection can be established using the first frequency band and the second access point with which a connection can be established using the second frequency band are activated. The MFP 100 may be capable of using only one frequency band and need not switch the connection destination based on the band steering function. Even in that form, the mobile terminal device 104 may switch the connection destination based on the band steering function.

A switch of the connection destination by the band steering function can be performed only among access points having the same ESSID. That is, it is assumed that the first access point and the second access point have the same ESSID. However, the first access point and the second access point need not have the same BSSID.

In one or more embodiments of the above description, it is assumed that the first access point and the second access point are enabled in one wireless LAN router in which this function is enabled, but they are not limited to this form. The first access point and the second access point may each be enabled in two separate wireless LAN routers in which this feature is enabled. Even in this form, however, it is assumed that the first access point and the second access point, which are to be subject to a switch of the connection destination based on the band steering function, have the same ESSID. In this form, the wireless LAN router in which the first access point is enabled instructs the mobile terminal device 104 to switch the connection destination to the second access point.

### Processing Performed in Response to Connection Destination Change Request from AP to STA in One or More Embodiments

The mobile terminal device 104 and the MFP 100 support a function disclosed as Wi-Fi Agile Multiband™. Wi-Fi Agile Multiband is a function that allows selection of an optimum environment according to the changing status of a Wi-Fi network. Specifically, STAs, such as the mobile terminal device 104 and the MFP 100, and an AP, such as the AP 101, exchange information related to the network environment using IEEE 802.11 series communication standards. Such exchange of information allows the AP to direct (cause) an STA (to change the connection destination) to another AP, frequency band, or channel and, in some cases, to another cellular service when the network is congested.

The IEEE 802.11 series communication standards to be used include IEEE 802.11k, IEEE 802.11v, and the like. IEEE 802.11k is a standard related to a function called Dynamic Monitoring. This function causes an AP to notify an STA of positions of neighboring APs, the strength of the beacon signal from each AP, a wireless LAN signal level in each channel, a non-wireless LAN signal level in each channel, and the like. IEEE 802.11v is a standard related to a function known as Wireless Network Management. This function provides a function for transferring communication of an STA to another AP and another frequency band or channel using results of measurement in which IEEE 802.11k is used.

FIG. 6 is a sequence diagram for when the MFP 100 switches the connection destination AP from the AP 101 to the AP 102 according to a connection destination change request from the AP 101 in one or more embodiments. The processes to be performed by the respective devices in this sequence are realized by the CPUs provided in the respective devices reading out, to the RAMs, various programs stored in memories such as the ROMs provided in the respective devices and executing the various programs.

In the initial state of the processing of FIG. 6, it is assumed that the MFP 100 has established a connection with the AP 101 in the wireless infrastructure mode. In one or more embodiments, the AP 101 is the above user-set AP. In addition, when the MFP 100 and the AP 101 connect in the wireless infrastructure mode, the AP 101 obtains information on whether the MFP 100 supports IEEE 802.11v. It is assumed that the following processing is performed when the AP 101 has obtained information that the MFP 100 supports IEEE 802.11v.

In step S601, the AP 101 transmits, to the MFP 100, a query (measurement request) for signal qualities (e.g., signal strengths) from APs in the vicinity of the MFP 100. This query (measurement request) can be transmitted including, for example, a beacon frame request or a beacon report request. That is, regarding this request, a mechanism specified in the IEEE 802.11k standard can be used. In one example, the measurement request may be a measurement instruction instructing the MFP 100 to measure the received signal strength or the signal-to-noise ratio of a given wireless signal, such as a beacon signal, transmitted from an AP in the vicinity of the MFP 100. In other words, the wireless unit 226 of the MFP 100 functions as a receiving unit capable of receiving a measurement request.

In step S602, in response to the request received in step S601, the MFP 100 receives frames transmitted by neighboring APs and measures the signal strengths (i.e., received signal strengths). By this, the signal strength of each of the plurality of the APs including the AP 101 and the AP 102 is measured. In one example, the MFP 100 may store the results measurement of received signal strengths of frames transmitted by neighboring APs as signal qualities in a storage device, such as the RAM 214 or the non-volatile memory 215. Therefore, in one or more embodiments, the CPU 212 of the MFP 100 functions as a measuring unit that measures the quality of signals from neighboring access points by controlling the wireless unit 226.

In step S603, the MFP 100 transmits a list of received signal strengths of APs in the vicinity of the MFP 100 measured in step S602 as a response to the request received in step S601. The received signal strengths to be returned may be, in addition to or instead of the information measured in step S602, information stored in the RAM 214, the non-volatile memory 215, or the like of the MFP 100. This response is transmitted including, for example, a Beacon Report or a measurement report.

In step S604, the AP 101 determines whether the connection destination of the MFP 100 needs to be switched based on the status of congestion in the network that the AP 101 is aware of and based on the received signal strength received in step S603 from the MFP 100. The reasons for the AP 101 to determine that the connection needs to be switched include there being many connected STAs, large communication volume, no congestion in another AP, whether there is an interference wave, stopping of the AP function, and the like. When it is determined that the connection destination of the MFP 100 needs to be switched and the SSID, the channel, and the frequency band of another AP to be designated as the switch destination of the MFP 100 are determined, the processing proceeds to step S605.

In step S605, the AP 101 transmits an AP change request (connection destination switch request or connection destination change request) to the MFP 100. A connection destination change request includes information on the SSID, the channel, and the frequency band of another AP to be designated as the switch destination for the MFP 100, which was determined in step S604. A plurality of SSIDs may be designated. A connection destination change request is transmitted as, for example, a BTM Request. That is, a BSS Transition Management (BTM) Request frame specified by the IEEE 802.11v standard is transmitted. In the example of FIG. 6, it is assumed that the AP 102 is designated as the switch destination included in the connection destination change request. Therefore, the wireless unit 226 of the MFP 100 functions as a receiving unit capable of receiving a connection destination change request in one or more embodiments.

In step S606, the MFP 100 transmits, to the AP 101, a response indicating acceptance of a switch when complying with the connection destination change request received in step S605. When not complying with the connection destination change request, the MFP 100 may transmit a switch rejection as a response. The response is transmitted as a BTM Response. In the example of FIG. 6, it is assumed that a response indicating acceptance is transmitted.

In step S607, the AP 101 and the MFP 100 disconnect the connection in the wireless infrastructure mode.

In step S608, the MFP 100 transmits a connection request to the AP 102 so as to connect to the AP 102 designated in the connection destination change request received in step S605.

By this, in step S609, a connection in the wireless infrastructure mode between the MFP 100 and the AP 102 is established.

With such a mechanism, the MFP 100, which is an STA, can change the connection destination from the AP 101 to the AP 102 based on a connection destination change request from the originally connected AP 101. The AP 101 and the AP 102 may be APs installed in different locations. That is, the processing of FIG. 6 allows the MFP 100 to switch to another AP installed in a location that is different from an AP to which it had originally been connected. Further, the APs may be those provided by the same device and each supporting a different frequency band among a plurality of frequency bands (any two or three among the 2.4-GHz band, the 5-GHz band, and the 6-GHz band). That is, the processing of FIG. 6 allows the MFP 100 to switch to another frequency band provided by the same device as that of an AP to which it had originally been connected. For example, the connection destination can be changed to a 6-GHz band AP based on a connection destination change request.

In one or more embodiments, an example in which a measurement request and a connection destination change request from an AP are transmitted and an STA responds thereto using a mechanism conforming to Wi-Fi Agile Multiband has been described, but the one or more embodiments of the present disclosure are not limited thereto. The one or more embodiments may be applied to that in which an STA responds to or changes the connection destination AP (switches, deletes, or adds an AP to be the connection destination) in response to a measurement request and a connection destination change request transmitted from an AP using a mechanism different from the above example.

### Beacon Report for One or More Embodiments

Here, the beacon report described above in step S603 will be described. The MFP 100 searches for neighboring APs or uses information of a prior search to create and transmit a beacon report to the AP 101. The MFP 100 can create a beacon report that does not include information related to APs if no AP is found and create a beacon report that includes information related to a plurality of APs if a plurality of APs are found. A beacon report may include, as signal qualities, the received signal strengths and the signal-to-noise ratios (S/N ratios) of given radio signals including a beacon signal transmitted from an AP. In one example, the signal qualities included in a beacon report may be associated with other parameters, such as measured time. Further, a beacon report may include a parameter indicating any signal quality, such as a delay profile, in addition to the received signal strength and the S/N ratio. Further, a beacon report can include additional information, such as a flag indicating being connected, for example, as information related to the connected AP.

A beacon report includes, for each AP, the channel number, the received signal strength, the S/N ratio, and a Basic Service Set Identifier (BSSID). Therefore, if there are a plurality of APs in the vicinity of the MFP 100, a beacon report may include measurement results for each of the plurality of APs. A channel number indicates the frequency band on which an AP was detected, the received signal strength indicates the received signal strength of the beacon signal received by the MFP 100 from the AP 101, and the S/N ratio indicates the signal-to-noise ratio of the beacon signal received by the MFP 100 from the AP 101. A BSSID is the identifier of the AP 101 that has been encoded in a beacon signal that the MFP 100 received from the AP 101.

### Response to Connection Destination AP Change Request for One or More Embodiments

An STA, such as the MFP 100, may receive a connection destination AP change request (connection destination change request) from the connection destination AP while connected to the AP. In such cases, there are states in which there will be no issue even if the connection destination AP is changed based on the connection destination AP connection destination change request transmitted from the connected AP and states in which there will be an issue or it is not desirable. In a state in which it is not desirable to change the connection destination AP based on a connection destination change request, one or a combination of a plurality of the following processes can be performed as prevention processing for preventing a change of the connection destination to be performed in response to the connection destination change request. The following prevention processes all are processing for preventing or making it difficult to perform a change of the connection destination AP that is based on the connection destination change request.

### Prevention Processing 1 for One or More Embodiments

In first prevention processing, even if the connection destination change request described in step S605 is received, the MFP 100 does not change the connection destination AP based on the received connection destination change request and does not return a response for the connection destination change request. Alternatively, the MFP 100 transmits a response indicating rejection to the connected AP for the connection destination change request. This is because when a rejection response is transmitted for the connection destination change request, the connection destination change priorities of other STAs connected to the AP to which the MFP 100 is connected increase, and the connection destination change priority of the MFP 100, which returned a rejection response, decreases. As a result, the connection with the connected AP may be maintained. In addition, it is considered that if a response is not returned for the connection destination change request (in the case of ignoring), the connected AP will maintain a connection with the MFP 100 so as to wait for a response until the response wait time elapses. Thus, if the state is such that the connected AP immediately disconnects the connection in response to some response from the MFP 100 for the connection destination change request, the time in which the connection with the connected AP can be maintained can be increased when not responding than when returning some response. Therefore, for example, based on change reason information included in the connection destination change request, different processes may be taken depending on the reason, such as returning a rejection if the reason is weak and ignoring the request if the reason is strong.

In one or more embodiments, the strength of the reason for changing the connection destination may be determined depending on, for example, whether the state is such that the AP 101 to which the MFP 100 is connected forcibly disconnects the connection with the MFP 100. Therefore, the strength of the reason for change can be determined based on, for example, information on which of a plurality of reasons included in a Request Mode included in a BTM Request applies. For example, if the Disassociation Imminent bit or the BSS Termination Included bit of the Request Mode is 1, it can be determined that the change request has a strong reason for change. Otherwise, it can be determined that the reason for change is weak. The Disassociation Imminent bit indicates that the connection with an STA, such as the MFP 100, will be released after a certain time has elapsed if that STA does not reconnect to another AP. The release of the connection in this specification is also referred to as disconnection of the connection. In addition, the BSS Termination Included bit indicates that, for example, a BSS or an AP multi-link device (MLD) is shutting down and the connection with the STA will be released. If disconnection is thus imminent, it can be determined that the reason for change is strong; otherwise, it can be determined that the reason for change is weak. By determining in advance information indicating a strong reason for change or criteria for determining that the reason for change is strong, it is possible to determine whether a connection destination change request has a strong reason or a weak reason.

### Prevention Processing 2 for One or More Embodiments

In second prevention processing, in response to the measurement request described in step S601, the MFP 100 returns (falsely responds with) information indicating that the signal qualities of non-connected APs, which are not an AP to which the MFP 100 is connected, are worse than the actually measured signal qualities. The signal qualities may, in other words, be referred to as radio wave reception conditions or signal reception conditions. In this case, in response to reception of a measurement request, response may be performed upon actual measurement of signal qualities or response may be performed without actual measurement. Specifically, in the response (e.g., a beacon report) described in step S603, signal qualities obtained by reducing the measured signal qualities of signals received from non-connected APs are returned. For example, if signal qualities are to be indicated using received signal strengths, received signal strengths indicating signal qualities may be returned with values obtained by reducing measured values. Alternatively, if signal qualities are to be indicated using noise, such as signal-to-noise ratios, signal-to-noise ratios may be returned with values obtained by increasing noise to be greater than measured values. Alternatively, both received signal strengths and signal-to-noise ratios may be returned with values indicating qualities that are lower than measured signal qualities.

Alternatively, the contents of a response may be such that at least one piece of information (e.g., a signal quality) for each non-connected AP is not included. Further, it is possible to only perform one of a process for reducing received signal strengths (signal qualities) to very low values or a process for responding with signal-to-noise ratio values obtained by significantly increasing noise based on previously measured information related to non-connected APs.

Further, even if a measurement request is received, a signal quality indicating a good received signal strength only for the connected AP or a noise status may be returned without performing actual measurement (AP search) and without including information on non-connected APs. Responding to a measurement request without including information related to non-connected APs corresponds to a response indicating that another, non-connected AP was not found even when an AP search was performed. That is, responding without including information related to non-connected APs is a response indicating at least some of the signal qualities from the non-connected AP to be worse than those for when an AP search is actually performed.

As such, in the prevention processing 2, in response to a measurement request from the connected AP, a response indicating that the signal quality of the connected AP is higher than the signal qualities of non-connected APs or a response indicating that no non-connected APs were found are made. By doing so, it can be expected that transmission of a request to change the connection destination to another AP from the connected AP can be prevented. Therefore, a change of the connection destination in response to a connection destination change request is prevented.

### Prevention Processing 3 for One or More Embodiments

In prevention processing 3, in response to a connection destination change request from the connected AP, the MFP 100 releases the connection with the connected AP once, notifies information that it does not support connection destination change requests, and reconnects with the same AP. Specifically, in preparation for disconnecting the wireless connection with the connected AP once and re-establishing a wireless connection, Association Request frame data including information indicating that IEEE 802.11v is not supported is created. Then, processing for connecting with the AP is performed using the created Association Request frame data. As a result, an Association Request frame including information that IEEE 802.11v is not supported is transmitted to the AP. Therefore, the MFP 100 connects with the AP as an electronic device that does not support (is incompatible with) the Agile Multiband function. As a result, the connected AP recognizes that the MFP 100 does not support IEEE 802.11v and no longer transmits a wireless connection destination change request to the MFP 100. The MFP 100 is thus no longer requested to change the wireless connection, and so, it becomes easier to maintain the wireless connection between the MFP 100 and the connected AP. In addition, when the connected AP recognizes that the MFP 100 does not support IEEE 802.11v, transmission of a measurement request (request described in step S601) from the connected AP to the MFP 100 is prevented. Therefore, it is possible to prevent measurement (AP search) and response to a measurement request (processing of step S603) performed in response to a measurement request in the MFP 100. Therefore, the processing load and power consumption can be reduced, and resources can be allocated to other processing.

The states in which a change of the connection destination AP based on a change request is undesirable include, for example, reception of print data being in progress, in addition to a firmware update being in progress. During print data reception in the MFP 100, the state is such that a part of the print data of an image to be printed has been received from the mobile terminal device 104, which is a partner device, and the remaining part of the print data has not been received. In the MFP 100, not all pieces of print data to be printed on one sheet are stored. Therefore, the MFP 100 performs printing by repeating: when a part of the print data is received, printing only the received part (e.g., receive and print one line), and when subsequent data is received, printing only that part. If the connection destination AP is changed based on a connection destination change request during this print data reception, a time lag associated with connection destination switch processing may occur, which leads to print quality degradation, such as uneven printing. Further, after the connection destination is switched, communication with the mobile terminal device 104, which is the partner device, may no longer work, resulting in not being able to receive subsequent data and thus printing failure. Therefore, while print data is being received, it is desirable to perform at least one of the processes in the above “(Prevention Processing 1)” and “(Prevention Processing 2)” as processing for preventing connection destination change performed in response to a change request, or before print data reception is started, it is desired that the processing in the above “(Prevention Processing 3)” be performed.

### Firmware Update Processing for One or More Embodiments

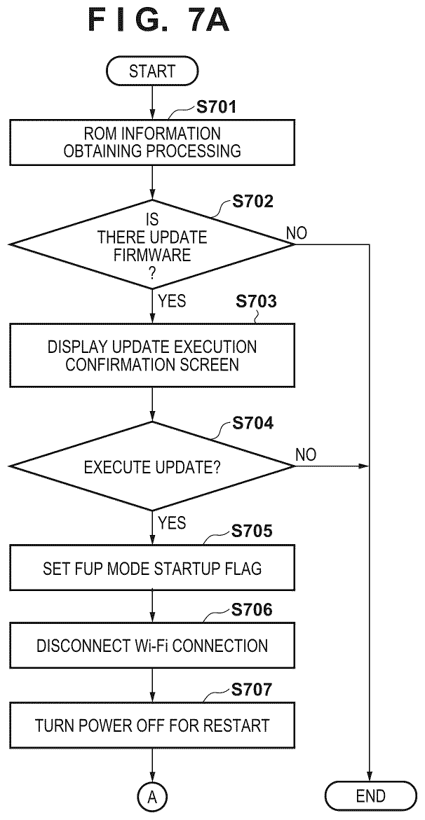

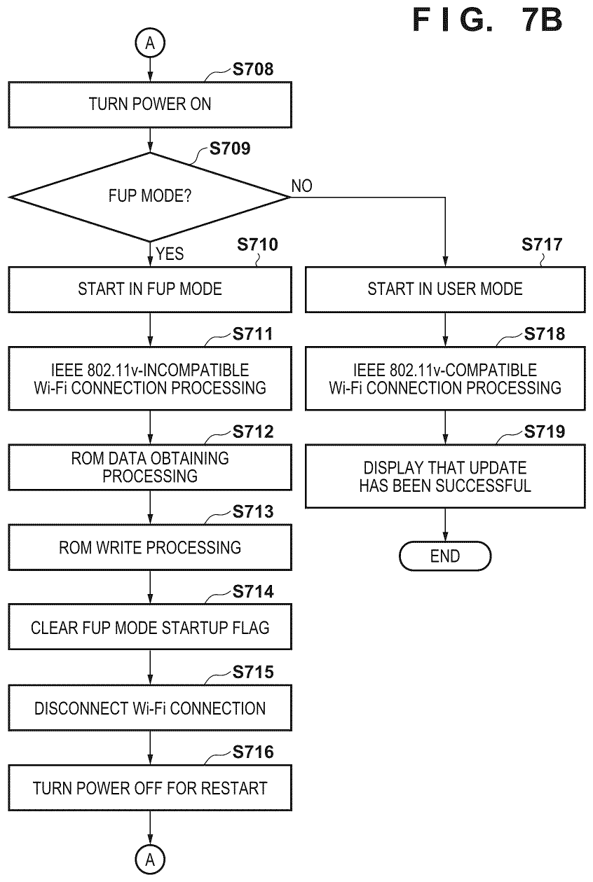

Next, processing in which the MFP 100 executes a firmware update (hereinafter, firmware update or FUP) will be described with reference to a flowchart of FIGS. 7A and 7B. The respective steps indicated in the flowchart of FIGS. 7A and 7B are processed by the CPU 212 loading a control program stored in a memory, such as the ROM 213, to the RAM 214 and executing the control program. FIGS. 7A and 7B indicate a procedure for realizing the prevention processing 3 during a firmware update.

FIGS. 7A and 7B are a flowchart for when the MFP 100 according to one or more embodiments executes a firmware update (hereinafter, firmware update or FUP). Here, it is assumed that the MFP 100 has established a connection with the AP 101 in the wireless infrastructure mode and is in a state in which it can communicate with the mobile terminal device 104, the ROM information server 106, and the ROM data server 107. In addition, it is assumed that the MFP 100 has a firmware update notification function for obtaining ROM information from the ROM information server 106 in the background and, if there is a newer version of the firmware (hereinafter, referred to as update firmware), notifies the user of that through a UI. This firmware update notification function may, for example, be periodically executed.

When a firmware update is triggered in the MFP 100, the following flow, which starts from step S701, is started. A trigger to start a firmware update may be any of the following triggers in one or more embodiments.
Trigger 1 (Manual Update): Reception of a firmware update transition operation from the user
Trigger 2 (Regular Update): Arrival of time set by the user Trigger 3 (Automatic Update): Continuation of a non-operation time for a given time in a state in which an automatic update setting is enabled
Trigger 4 (External Client Update): Reception of a firmware update operation from an external client tool
Trigger 5 (Update During Power-off): Reception of a power-off operation from the user in a state in which a firmware update notification setting during power-off is enabled

Here, the firmware update transition operation of trigger 1 (manual update) includes an operation for selecting execution of a firmware update from a menu in the operation display unit 205 of the MFP 100. Alternatively, the operation may be that for accessing a remote UI of the MFP 100 from the mobile terminal device 104 and selecting execution of a firmware update in a menu on the remote UI. When the firmware update notification setting is enabled, a message that there is update firmware is displayed the operation display unit 205 of the MFP 100, and so, the user can perform a manual update after confirming that there is update firmware.

In step S701, the CPU 212 performs processing for accessing the ROM information server 106 and obtaining ROM information. Hypertext Transfer Protocol (HTTP) or HTTPS for which HTTP is made secure by Transport Layer Security (TLS) is used for communication with the ROM information server 106. The ROM information includes information related to firmware of the MFP 100, such as the ROM version, a URL or URI as a storage destination of ROM data, and the ROM size.

Then, in step S702, the CPU 212 compares the ROM version included in the ROM information obtained in step S701 with the version of the currently operating ROM and determines whether there is update firmware. If there is update firmware (if it is YES in step S702), the processing proceeds to step S703; if there is no update firmware (if it is NO in step S702), the flow of FIGS. 7A and 7B is terminated.

In step S703, the CPU 212 displays a screen for receiving an instruction for whether to execute a firmware update and prompts the user for input. However, in the case of trigger 2 (regular update), trigger 3 (automatic update), and trigger 4 (external client update), the confirmation screen of step S703 is not displayed. This is because the user is not necessarily within a range in which they can operate the MFP 100. Therefore, in this case, it will be deemed that the user has selected to execute a firmware update (YES in step S704, which will be described later). In addition, in the case of trigger 5 (update during a power-off), if a state in which there is no input on the confirmation screen of step S703 continues for a given time, it is assumed that execution of a firmware update was not selected (NO in step S704, which will be described below) and the flowchart of FIGS. 7A and 7B is terminated, and a normal power-off operation is executed. A normal power-off operation will be described in step S707.

In step S704, if the user has selected to execute a firmware update (YES in step S704), the processing proceeds to step S705, and if the user has not selected to execute a firmware update (NO in step S704), the flow of FIGS. 7A and 7B is terminated.

In step S705, the CPU 212 sets, in the non-volatile memory 215, a FUP mode startup flag for starting in the firmware update mode next time.

In step S706, the CPU 212 disconnects the wireless infrastructure connection with the AP 101.

In step S707, the CPU 212 executes power-off processing for restarting the MFP 100. In normal power-off processing, the power-off state is entered after execution of a termination sequence, which is a sequence for terminating each unit on the main board 211 of the MFP 100, and a press of a power key of the operation display unit 205 is awaited. In contrast to that, the power-off processing for restart is processing for executing the same termination sequence as the normal power-off processing and then, instead of waiting in the power-off state, continuously starting power-on processing.

In step S708, the CPU 212 performs power-on processing. This is a startup sequence for initializing each unit on the main board 211 of the MFP 100 and is the same as a normal power-on operation in which the MFP 100 is started by a press of the power key of the operation display unit 205 when the MFP 100 is the power-off state. In the flowchart of one or more embodiments, it is executed subsequently to the restart power-off processing of step S707 or S716 as a sequence for restarting the MFP 100.

In step S709, the CPU 212 determines the startup mode by referencing the FUP mode startup flag. In the case of startup in a state in which the FUP mode startup flag is set in the non-volatile memory 215, it is determined that the startup mode is the firmware update mode (YES in step S709), and the processing proceeds to step S710. Meanwhile, in the case of startup in a state in which the FUP mode startup flag is cleared, it is determined that the startup mode is not the firmware update mode (NO in step S709), the processing proceeds to step S717, and startup is performed in user mode.

In step S710, the CPU 212 starts the MFP 100 in the firmware update mode. The firmware update mode is a mode dedicated to updating of firmware of the MFP 100, and only the software modules necessary for a firmware update are started.

In step S711, the CPU 212 transmits an Association Request frame that includes information that IEEE 802.11v is not supported to the AP 101, which is stored in the non-volatile memory 215 as the connection destination AP, to establish the wireless infrastructure connection. In detail, the connection processing described in the above “(Prevention Processing 3)” is performed. When thus connected with the AP 101, while the MFP 100 is operating in the firmware update mode, the MFP 100 will not receive a measurement request or a connection destination change request from the AP 101. That is, by executing this processing, one or more embodiments perform control so as to prevent the connection destination AP from being switched during a firmware update. As a result, it is possible to avoid a communication error caused by a switch of the connection destination AP during a firmware update and prevent firmware update failure.

In step S712, the CPU 212 performs ROM data obtaining processing. In the ROM data obtaining processing, ROM data, which is actual update firmware, is downloaded from the ROM data server 107 based on the ROM data storage destination URL included in the ROM information obtained in step S701. HTTP or HTTPS is used for communication with the ROM data server 107. In the ROM data obtaining processing, authenticity verification, such as tampering detection and checksum calculation for the obtained ROM data, is performed.

In step S713, the CPU 212 performs ROM write processing in which the ROM data obtained in step S710 is written to the ROM 213.

When the ROM write processing of step S713 is completed, in step S714, the CPU 212 clears the FUP mode startup flag set in step S705.

In step S715, the CPU 212 disconnects the wireless infrastructure connection with the AP 101, similarly to step S706.

In step S716, the CPU 212 performs restart power-off processing, similarly to step S707. Then, the processing proceeds to step S708, and the MFP 100 is started. If the MFP 100 is restarted in a state in which the FUP mode startup flag is cleared, the determination of step S709 will be determined to be NO, and so, the processing proceeds to step S717.

In step S717, the CPU 212 starts the MFP 100 in the user mode. The user mode is a mode in which the functions provided by the MFP 100, such as printing and scanning, can be used.

In step S718, the CPU 212 transmits an Association Request frame that includes information that IEEE 802.11v is supported to the AP 101, which is stored in the non-volatile memory 215 as the connection destination AP, to establish the wireless infrastructure connection. The prevention processes described in the above “(Prevention Processing 1)” to “(Prevention Processing 3)” are not performed, and so connection with an AP is established as an electronic device that supports the Agile Multiband function from the perspective of the AP 101.

In step S719, the CPU 212 displays a message that the firmware update has been successful on the operation display unit 205 and terminates the sequence of flow of FIGS. 7A and 7B. Then, a state in which the user can use the functions provided by the MFP 100 according to the updated firmware is entered.

As described above, according to one or more embodiments, the MFP 100 reconnects with the AP as a device not supporting IEEE 802.11v prior to firmware update processing. By this, measurement requests and AP connection destination change requests complying with the IEEE 802.11v standard will not be received from the connected AP. Therefore, a change of the AP during firmware update processing can be prevented and signal qualities no longer need to be measured in response to a measurement request, and so, reliability and promptness of the firmware update processing can be realized. In addition, the device, by reconnecting with the AP as that which supports IEEE 802.11v after the firmware update processing, can dynamically change the connected AP and perform high-quality communication.

### Second Embodiment

In the first embodiment, a form in which the MFP 100 disconnects the connection with the AP and turns the power off based on a trigger to transition to the FUP mode and starts in the FUP mode and reconnects with the AP has been described. That is, in the first embodiment, the prevention processing 3 is executed. In contrast to that, in the second embodiment, a form in which the FUP mode is transitioned to based on a trigger to transition to the FUP mode, without turning the power off and without disconnecting the connection with an AP but rather maintaining the connection will be described. That is, in one or more embodiments, the prevention processing 1 and the prevention processing 2 described in the first embodiment are executed. In one or more embodiments, the devices in the wireless communication system and the system are in common with the first embodiment as illustrated in FIGS. 1 to 6.

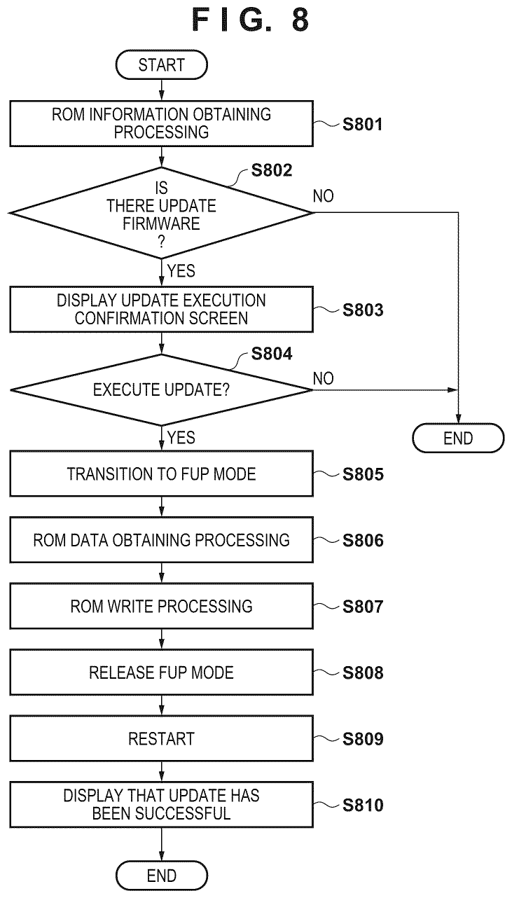

FIG. 8 is a flowchart for when the MFP 100 executes a firmware update according to one or more embodiments. Here, it is assumed that the MFP 100 has established a connection with the AP 101 in the wireless infrastructure mode and is in a state in which it can communicate with the mobile terminal device 104, the ROM information server 106, and the ROM data server 107. In addition, it is assumed that the MFP 100 has the firmware update notification function as in the first embodiment. The respective steps indicated in the flowchart of FIG. 8 are processed by the CPU 212 loading a control program stored in a memory, such as the ROM 213, to the RAM 214 and executing the control program.

When a firmware update is triggered in the MFP 100, the following flow, which starts from step S801, is started. The trigger to start a firmware update is similar to that of the first embodiment.

In step S801, the CPU 212 performs processing for accessing the ROM information server 106 and obtaining ROM information. HTTP or HTTPS is used for communication with the ROM information server 106. The ROM information includes information related to firmware of the MFP 100, such as the ROM version, a storage destination URL of ROM data, and the ROM size.

Then, in step S802, the CPU 212 compares the ROM version included in the ROM information obtained in step S801 with the version of the currently operating ROM and determines whether there is update firmware. If there is update firmware (if it is YES in step S802), the processing proceeds to step S803; if there is no update firmware (if it is NO in step S802), the flow of FIG. 8 is terminated.

In step S803, the CPU 212 displays a screen for receiving an instruction for whether to execute a firmware update and prompts the user for input. However, in the case of trigger 2 (regular update), trigger 3 (automatic update), and trigger 4 (external client update), the confirmation screen of step S803 is not displayed. This is because the user is not necessarily within a range in which they can operate the MFP 100. Therefore, in this case, it will be deemed that the user has selected to execute a firmware update (YES in step S804, which will be described later). In addition, in the case of trigger 5 (update during a power-off), if a state in which there is no input on the confirmation screen of step S803 continues for a given time, it is assumed that execution of a firmware update was not selected (NO in step S804, which will be described below) and the flowchart of FIG. 8 is terminated, and a normal power-off operation is executed. The normal power-off operation is as described in step S707 of FIG. 7A.

In step S804, if the user has selected to execute a firmware update (YES in step S804), the processing proceeds to step S805, and if the user has not selected to execute a firmware update (NO in step S804), the flow of FIG. 8 is terminated.

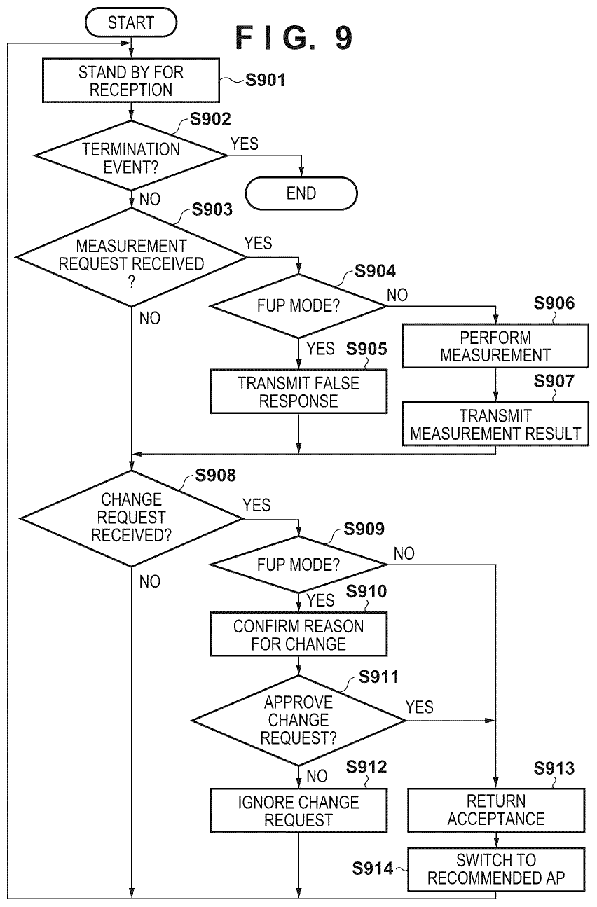

In step S805, the CPU 212 causes the MFP 100 to transition to the FUP mode while maintaining the wireless connection with the AP 101. When the FUP mode is transitioned to, operations such as printing and scanning will be excluded, and job processing other than firmware update will not be allowed to be executed. In addition, while in the FUP mode, the MFP 100 falsely responds to connection destination change requests from the AP 101. These will be described in detail with reference to FIG. 9. Whether the MFP 100 is in the FUP mode can be determined, for example, by storing information indicating the FUP mode in the RAM 214 or the like and testing that.

In step S806, the CPU 212 performs ROM data obtaining processing. In the ROM data obtaining processing, ROM data, which is actual update firmware, is downloaded from the ROM data server 107 based on the ROM data storage destination URL included the ROM information obtained in step S801. HTTP or HTTPS is used for communication with the ROM data server 107. In the ROM data obtaining processing, authenticity verification, such as tampering detection and checksum calculation for the obtained ROM data, is performed.

In step S807, the CPU 212 performs ROM write processing in which the ROM data obtained in step S806 is written to the ROM 213.

The CPU 212, in step S808, releases the FUP mode and, subsequently, in step S809, restarts the MFP 100. When the startup processing is completed, in step S810, the CPU 212 displays a message that the firmware update has been successful and terminates the sequence of flow of FIG. 8. Then, a state in which the user can use the functions provided by the MFP 100 according to the updated firmware is entered.

FIG. 9 is a flowchart for explaining control of the MFP 100 for a measurement request and a connection destination change request to the MFP 100 from the AP 101. A new connection destination for which a request is made by a connection destination change request may be, for example, the AP 102. A connection destination change request may simply be referred to as a change request. The flowchart indicated in FIG. 9 is started, triggered by establishment of an infrastructure connection between the AP 101 and the MFP 100.

In step S901, the CPU 212 waits to receive a measurement request or a connection destination change request transmitted from the AP 101 or an event that occurred in the MFP 100.

In step S902, the CPU 212 determines whether the event is a termination event, such as the wireless communication being turned off or the power being turned off. If it is determined that the event is a termination event (YES in step S902), the flow of FIG. 9 is terminated; if it is determined that the event is not a termination event (NO in step S902), the processing proceeds to step S903.

In step S903, the CPU 212 determines whether a measurement request (corresponding to above step S601 of FIG. 6) has been received from the AP 101. If a measurement request has been received (YES in step S903), the processing proceeds to step S904; if a measurement request has not been received (NO in step S903), the processing proceeds to step S908.

In step S904, the CPU 212 determines whether the mode is the firmware update mode. If it is determined that the mode is the FUP mode (YES in step S904), the processing proceeds to step S905; if it is determined that the mode is not the FUP mode (NO in step S904), the processing proceeds to step S906.

In step S905, the CPU 212 transmits a false response to the AP 101. By executing this processing, one or more embodiments perform control so as to prevent the connection destination AP from being switched during a firmware update. Regarding the contents of the false response, the response may be any response in the above “(Prevention Processing 2)”. However, when in the FUP mode, it is desirable to respond with either or both a good received signal strength and a good noise status only for the connected AP, without performing actual measurement (AP search) and without including information on non-connected APs. That is, it is desirable to return a response indicating that the quality of communication from the connected AP to the MFP 1001 is good. This is because during a firmware update, no other job processing is performed, and after the update is completed, restart is performed and connection is re-established using the updated firmware, and so, measurement for changing the connection destination will be meaningless. As a result, it can be expected that transmission of a request to change the connection destination to another AP from the connected AP 101 will be prevented during a firmware update.

In step S906, the CPU 212 receives a frame transmitted by an AP in the vicinity of the MFP 100 and measures a signal strength (signal quality). The index values of signal qualities to be measured may include not only a signal strength but also, for example, a signal to noise ratio and the like. In step S907, the CPU 212 transmits, as a response to the request received in step S901, a list of signal strengths (signal qualities) of APs in the vicinity of the MFP 100 measured in step S906. The processing of steps S906 and S907 is processing that corresponds to above steps S602 and S603 of FIG. 6.

In step S908, the CPU 212 determines whether a change request (BTM Request; corresponding to above step S605 of FIG. 6) has been received from the AP 101. If a change request has been received (YES in step S908), the processing proceeds to step S909; if a change request has not been received (NO in step S908), the processing returns to reception standby of step S901.

In step S909, the CPU 212 determines whether the mode is the FUP mode, similarly to step S904. If it is determined that the mode is the FUP mode (YES in step S909), the processing proceeds to step S910; if it is determined that the mode is not the FUP mode (NO in step S909), the processing proceeds to step S913.

In step S910, the CPU 212 confirms the reason for change included in the received change request. As described in above “(Prevention Processing 1)”, the reason for change can be determined based on, for example, information on which of a plurality of reasons included in a Request Mode included in a BTM Request applies. For example, if the Disassociation Imminent bit or the BSS Termination Included bit of the Request Mode is 1, it can be determined that the change request has a strong reason for change. This is because these information bits can be considered to indicate an imminent disconnection from the transmission source AP. Otherwise, it can be determined that the reason for change is weak. This is as prevention processing 1 has been described in the first embodiment.

In step S911, the CPU 212 determines whether to accept the change request. The CPU 212 accepts the change request if the reason is strong as a result of confirming the reason for change in step S910 and does not accept the change request if the reason is weak. Further, whether to accept the change request may be determined taking factors other than the strength of the reason for change into consideration. For example, in the firmware update (FUP) mode, the size of update firmware to be downloaded is ascertained in advance according to the ROM size included in the ROM information. Therefore, whether to accept the change request is determined taking the remaining size of the download into consideration. For example, if the remaining size is a given amount or less, the change request may be accepted. That is, for example, if the remaining size is a given amount or less, the reason for change may be deemed weak. Further, the CPU 212 may calculate an estimated remaining time from a link rate of the connected AP and a time elapsed from the start of update firmware download and, taking these into consideration, determine whether to accept the change request. When taking factors other than the reason for change into consideration, a configuration may be taken so as to, for example, if the reason for change is weak and a remaining time required for downloading firmware is within a given time that has been defined in advance, accept the change request and, otherwise, not accept the change request. Alternatively, a configuration may be taken so as to, even if the reason for change is strong, if a remaining time required for downloading firmware is within a given time that has been defined in advance, ignore the change request. In any case, if it is expected that the firmware download will be completed prior to disconnection from the AP, the change request may be ignored; if that is not expected to be the case, the change request may be accepted. In this case, if the reason for change is strong and it is unknown whether it is expected that the firmware will be downloaded prior to disconnection from the AP, it may be deemed that it is not expected and the change request may be accepted. In the case of accepting the change request (YES in step S911), the processing proceeds to step S913; in the case of not accepting the change request (NO in step S911), the processing proceeds to step S912.

In step S912, the CPU 212 ignores the received change request (does not return a response to the change request) and returns the processing to step S901. With this, it can be expected that the connection with the connection destination AP 101 will be maintained until a response wait time for a change request times out at the AP 101.

Meanwhile, in step S913, the CPU 212 returns that it has accepted the received change request. In step S914, the CPU 212 switches the connection to the AP 102, which is designated in the received change request. The processing of steps S913 and S914 is processing that corresponds to above steps S606 and S609 of FIG. 6. Upon establishing a connection with a post-connection-destination-change AP, such as the AP 102, the processing returns to step S901, and thereafter, reception of a change request transmitted from the AP 102 or an event generated in the MFP 100 is awaited.

According to one or more embodiments described above, regarding a measurement request during a firmware update, a response indicating that the state of communication with the currently connected access point is good and not including the states of communication with other access points is returned. With this, subsequent connection destination change requests are prevented, and thereby, firmware update failure caused by a switch of the connected AP can be prevented.

Further, regarding a connection destination access point change request during a firmware update, the access point is changed in response to the change request depending on the extent that release of connection with the connected access point is imminent, such as the strength of the reason for change, and if the access point is to not be changed, the change request is ignored. With this, it is possible to prevent change of the access point until a maximum time for waiting for a response to a change request expires. Further, by completing firmware download in that time, it is possible to prevent firmware update failure attributable to access point change.

### Modification of Above Embodiments

In the first embodiment, when restarting in the FUP mode and re-establishing a connection in step S711, a wireless infrastructure connection with the AP is established by transmitting a frame that includes information that IEEE 802.11v is not supported. However, it goes without saying that in the first embodiment, a configuration may be taken so as to, when re-establishing a connection, establish a connection with the AP by transmitting a frame that includes information that IEEE 802.11v is supported and perform a false response as described in FIG. 9.

Further, in the second embodiment, a configuration has been taken so as to transition to the FUP mode while maintaining a connection with the AP 101 and, during the FUP mode, perform a false response. However, similarly to the first embodiment, it goes without saying that in the second embodiment, a configuration may be taken so as to, when transitioning to the FUP mode, disconnect the connection with the AP once and, when re-establishing the connection, establish the connection with the AP as an STA that does not support IEEE 802.11v.

In the example of FIG. 9, steps S904 and S909 have been described to be those that determine whether the mode is the FUP mode; however, they are applicable to determination of another mode or the state, such as printing is in progress or scanning is in progress. Further, the processing of steps S910 and S911 can be omitted, in which case either ignoring or acceptance is performed depending on the result of mode determination in step S909. That is, in step S909, if it is determined that the mode is the firmware update mode, the change request is ignored; if it is determined otherwise, the change request is accepted and the access point is changed.

Further, in step S912 of FIG. 9, the change request is ignored without a response but a rejection response may be returned. Doing so may increase the connection destination change priorities of other STAs connected to the AP to which the MFP 100 is connected and reduce the connection destination change priority of the MFP 100 which returned a rejection response. As a result, the connection with the connected AP may be maintained.

Further, in the above description, a form in which the program to be updated is firmware and control is performed so as not prevent the connection destination AP from being switched during a firmware update has been described, but the one or more embodiments of the present disclosure are not limited to this form. The program to be updated may be a program other than firmware. Specifically, for example, a program to be updated may be an OS, a driver, or an application program, and a form in which control is performed so as to prevent the connection destination AP from being switched while the program is being updated may be taken.

The above various kinds of control described to be performed by the CPU 212 may be performed by a single piece of hardware, or control of the entire device may be performed by a plurality of pieces of hardware (e.g., a plurality of processors and circuits) sharing processing.

Further, although one or more features of the present disclosure have been described in detail based on one or more embodiments thereof, the scope of the present disclosure is not limited to these one or more embodiments, and various forms in a scope that does not depart from the gist of one or more features/aspects of the present disclosure are also included in the scope of the present disclosure. Further, each of the above embodiments merely illustrates one embodiment of one or more features of the present disclosure, and the embodiments can be combined as appropriate (and other configurations may be used in one or more embodiments of the present disclosure).

Further, in one or more embodiments described above, description has been given using as an example a case where one or more features of the present disclosure have been applied to an MFP; however, the features and scope of the present disclosure are not limited to this example, and any wireless device that functions as an STA capable of performing processing in response to a connection destination change request from an AP is applicable. That is, and for example, one or more features of the present disclosure are applicable to a personal computer, a PDA, a tablet terminal, a mobile telephone terminal (e.g., a smartphone), a music player, a game console, an electronic book reader, a smartwatch, and various measuring devices (sensor devices such as a thermometer and a hygrometer). Further, and by way of further examples, one or more features of the present disclosure are applicable to a digital camera (including a still camera, a video camera, a network camera, and a security camera), a printer, a scanner, and a drone. Further, and by way of additional further examples, one or more features of the present disclosure are applicable to a video output device, an audio output device (e.g., a smart speaker), a media streaming player, a wireless LAN station (adapter) that can be connected to a USB terminal or a LAN cable terminal, and the like. The video output device includes a device such as a set-top box, for example, and obtains (downloads) a moving image or a still image on the Internet identified by a URL instructed by the electronic device and outputs it to a display device connected through a video output terminal, such as HDMI®. By this, streaming reproduction in a display device is realized and mirroring display (display in which the content displayed on an electronic device is also displayed on a display device) is realized. Further, the video output device includes a media player (e.g., a TV, a hard disk recorder, a Blu-ray recorder, a DVD recorder), a head-mounted display, a projector, a TV, a display device (monitor), a signage device, and the like. One or more features of the present disclosure are also applicable to a device capable of Wi-Fi connection, which is a so-called smart home appliance, such as an air conditioner, a refrigerator, a washing machine, a vacuum cleaner, an oven, a microwave oven, a lighting fixture, a heating appliance, and a cooling appliance. Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While one or more features of the present disclosure have been described with reference to exemplary embodiments, it is to be understood that the scope of the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-013306, filed Jan. 31, 2024, which is hereby incorporated by reference herein in its entirety.

What is claimed is:

1. An electronic device capable of communicating with an external access point, the electronic device comprising:
at least one memory storing instructions; and
at least one processor that is in communication with the at least one memory and that, when executing the instructions, cooperates and operates with the at least one memory to execute processing, the processing including:
establishing a first connection between the electronic device and a first access point;
receiving, from the first access point, a first change request requesting a change of a connection destination of the electronic device;
based on the first change request being received, changing the connection destination of the electronic device to a second access point included in one or more access points corresponding to information included in the first change request;
in a state in which the first connection has been established, based on a predetermined trigger for updating a predetermined program included in the electronic device having occurred, executing a first processing for disconnecting the first connection and a second processing for establishing a second connection between the electronic device and the first access point;
executing a predetermined control for preventing reception of the first change request via the second connection established by the second processing being executed based on the predetermined trigger having occurred; and
based on information received via the second connection established by the second processing being executed based on the predetermined trigger having occurred, updating the predetermined program.

2. The electronic device according to claim 1, wherein:
based on the predetermined trigger having occurred, processing for turning a power of the electronic device off and processing for turning the power of the electronic device on are executed, and
after the processing for turning the power of the electronic device on has been executed, the second connection is established.

3. The electronic device according to claim 1, wherein the processing further includes:
based on an update of the predetermined program being completed, executing the first processing and the second processing; and
based on an update of the predetermined program being completed, performing control so as to receive the first change request via the second connection established by the second processing being executed.

4. The electronic device according to claim 3, wherein:
based on an update of the predetermined program being completed, processing for turning a power of the electronic device off and processing for turning the power of the electronic device on are executed, and
after the processing for turning the power of the electronic device on has been executed, the second connection is established.

5. The electronic device according to claim 4, wherein the processing further includes:
after the processing for turning the power of the electronic device on has been executed, displaying a message indicating that an update of the predetermined program has been successful.

6. The electronic device according to claim 5, wherein the processing further includes:
based on execution of processing for receiving predetermined data different from information for updating the predetermined program, executing prevention processing for preventing a change of the connection destination of the electronic device in response to the first change request.

7. The electronic device according to claim 6, wherein:
the prevention processing is a control for, even in a case where the first change request is received from the first access point, not executing a change of the connection destination of the electronic device in response to the first change request.

8. The electronic device according to claim 6, wherein:
the prevention processing is a control for, even in a case where the first change request is received from the first access point, transmitting a response indicating not executing a change of the connection destination of the electronic device in response to the first change request.

9. The electronic device according to claim 6, wherein:
the prevention processing is a control for, even in a case where a measurement request requesting a measurement of a signal quality is received from the first access point, not transmitting a value obtained by the measurement that has actually been executed in response to the measurement request.

10. The electronic device according to claim 6, wherein:
the prevention processing includes processing for performing a control so as to not receive the first change request via the first connection established by the first processing and the second processing being executed.

11. The electronic device according to claim 6, wherein:
the predetermined data is print data.

12. The electronic device according to claim 1, wherein the processing further includes:
receiving, from the first access point, a measurement request requesting measurement of a signal quality;
based on the measurement request being received, measuring the signal quality; and
transmitting information indicating the measured signal quality to the first access point,
wherein the first change request is transmitted from the first access point based on the information indicating the measured signal quality.

13. The electronic device according to claim 12, wherein:
the predetermined control is a control so as to not receive the measurement request and the first change request via the second connection established by the second processing being executed based on the predetermined trigger having occurred.

14. The electronic device according to claim 1, wherein:
the predetermined control is a control for transmitting, to the first access point, information indicating that a function for changing the connection destination of the electronic device is not supported based on the first change request being received.

15. The electronic device according to claim 1, wherein:
a change of the connection destination of the electronic device executed based on the first change request being received is executed based on a Wi-Fi Agile Multiband function.

16. The electronic device according to claim 1, wherein:
the first access point and the second access point each support a different frequency band.

17. The electronic device according to claim 1, wherein:
the predetermined program is a firmware.

18. The electronic device according to claim 1, wherein the processing further includes:
executing at least one among a printing and a scanning.

19. A method of controlling an electronic device capable of communicating with an external access point, the method comprising:
establishing a first connection between the electronic device and a first access point;
receiving, from the first access point, a first change request requesting a change of a connection destination of the electronic device;
based on the first change request being received, changing the connection destination of the electronic device to a second access point included in one or more access points corresponding to information included in the first change request;
in a state in which the first connection has been established, based on a predetermined trigger for updating a predetermined program included in the electronic device having occurred, executing a first processing for disconnecting the first connection and a second processing for establishing a second connection between the electronic device and the first access point;
executing a predetermined control for preventing reception of the first change request via the second connection established by the second processing being executed based on the predetermined trigger having occurred; and
based on information received via the second connection established by the second processing being executed based on the predetermined trigger having occurred, updating the predetermined program.

20. A non-transitory computer readable medium storing a program that, when executed by an electronic device capable of communicating or operating to communicate with an external access point, causes the electronic device to perform a method, the method comprising:
establishing a first connection between the electronic device and a first access point;
receiving, from the first access point, a first change request requesting a change of a connection destination of the electronic device;
based on the first change request being received, changing the connection destination of the electronic device to a second access point included in one or more access points corresponding to information included in the first change request;
in a state in which the first connection has been established, based on a predetermined trigger for updating a predetermined program included in the electronic device having occurred, executing a first processing for disconnecting the first connection and a second processing for establishing a second connection between the electronic device and the first access point;
executing a predetermined control for preventing reception of the first change request via the second connection established by the second processing being executed based on the predetermined trigger having occurred; and
based on information received via the second connection established by the second processing being executed based on the predetermined trigger having occurred, updating the predetermined program.
